(19) United States
(12) Patent Application Publication
(10) Pub. No.: US 2015/0295424 A1
(43) Pub. Date: Oct. 15, 2015

(54) Equalization Device

(71) Applicant: YAZAKI CORPORATION, Minato-ku, Tokyo (JP)

(72) Inventor: Shingo Suzuki, Susono-shi (JP)

(73) Assignee: YAZAKI CORPORATION, Minato-ku, Tokyo (JP)

(21) Appl. No.: 14/436,102

(22) PCT Filed: Sep. 26, 2013
(86) PCT No.: PCT/JP2013/076141

§ 371 Date: Apr. 16, 2015

(30) Foreign Application Priority Data
Oct. 18, 2012 (JP) 2012-230605

(51) Int. Cl. H02J 7/00

(52) U.S. Cl. CPC H02J 7/0014; H02J 7/0021

(57) ABSTRACT

An MCU (4) classifies the levels of the voltages across both ends of respective unit cells (C₁ to C₅) into levels “long discharge”, “normal discharge”, “short discharge” and “no discharge”, and on/off controls switches so that the unit cell (C₄) having the level “no discharge” closest to a reference voltage is not discharged and so that, among from the unit cells (C₁ to C₃ and C₅) having the other levels, the unit cell having a level farther from the reference voltage is discharged longer.

### TECHNICAL FIELD

The present invention relates to an equalization device, more particularly, to an equalization device for equalizing the voltages across both ends of a plurality of unit cells mutually connected in series.

### BACKGROUND ART

For example, a battery pack to be mounted on a hybrid automobile or an electric automobile is composed of a plurality of unit cells mutually connected in series, a high voltage of 200 V for example is generated across both ends thereof, and electric power generated is supplied to a drive motor. If variation occurs in the voltages across both ends of the respective unit cells of the battery pack configured as described above, there is a danger that the utilization efficiency of the battery pack lowers or the battery pack is overcharged. Accordingly, an equalization device has been proposed which performs equalization by discharging unit cells using discharge resistors so that the voltages across both ends of the unit cells become close to a minimum value (for example, Patent Document 1).

The conventional equalization using the discharge resistors will be described referring to FIGS. 6(A) and 6(B). The equalization device detects the voltages across both ends of unit cells C₁ to C₅ by using, for example, the off operation of the ignition switch as a trigger, sets the minimum value of the detected voltages across both ends of the unit cells C₁ to C₅ to a reference voltage, sets a voltage slightly higher than that to a target voltage (threshold value 1) and sets a voltage slightly higher than the target voltage to a threshold value 2. Next, in the case that the voltages across both ends of some of the unit cells C₁ to C₅ are higher than the threshold value 1, the equalization device starts equalization and discharges, for only a specified time, the unit cells C₁, C₂, C₃ and C₅ having the voltages across both ends thereof higher than the target voltage. This discharging is repeated until the voltages across both ends of all the unit cells C₁ to C₅ become equal to or lower than the target voltage. After the equalization, in the case that the voltages across both ends of some of the unit cells C₁ to C₅ are higher than the threshold value 2, the equalization device starts equalization and discharges, for only the specified time, the unit cells C₁, C₂, C₃ and C₅ having the voltages across both ends thereof higher than the target voltage.

### PRIOR ART DOCUMENT

### Patent Document

Patent Document 1: JP-A-2010-263733

### SUMMARY OF THE INVENTION

### Problems to be Solved by the Invention

However, since the discharge times for all the unit cells C₁, C₂, C₃ and C₅ having voltages higher than the target voltage are constant, i.e., the specified time, the discharge amounts of all the unit cells become equal as indicated by the oblique line portions in FIG. 6(B). Hence, in the case that the specified time is set long, the unit cells originally having voltages close to the target voltage are over-discharged and the capacities thereof may be wasted. In the example shown in FIG. 6(B), the unit cells C₂ and C₃ are over-discharged and the voltages thereof have become lower than the reference voltage. Furthermore, there is a danger that the variation in the cells C₁ to C₅ may become larger by the over-discharging. On the other hand, if the specified time is set shorter to prevent the occurrence of the above situation, the time required for adjusting the voltages across both ends becomes longer correspondingly.

In consideration of the above circumstances, the present invention is intended to provide an equalization device capable of performing quick and accurate equalization with a simple configuration.

### Means for Solving the Problems

For the purpose of solving the above problems, as a voltage detection apparatus according to a first aspect of the present invention, an equalization device for equalizing voltages across both ends of a plurality of unit cells mutually connected in series is provided, the equalization device being equipped with a voltage detection section that detects the voltages across both ends of the respective unit cells; a plurality of discharge resistors that discharge the unit cells, each of the unit cells being provided for each of the unit cells; a plurality of switches configured to connect the unit cells to the discharge resistors; and an equalization section that equalizes the unit cells by controlling the switches, wherein the equalization section defines the lowest voltage of the voltages across both ends detected by the voltage detection sections as a reference voltage, and is equipped with a classification section that classifies the voltages across both ends of the respective unit cells into 3 or more in accordance with the differences between the reference voltage and the voltages across both ends of the respective unit cells detected by the voltage detection sections, and a switch control section that on/off controls the switches so that the unit cell having the level closest to the reference voltage is not discharged and so that, among from the unit cells having the other levels, the unit cell having a level farther from the reference voltage is discharged longer.

Furthermore, as a voltage detection apparatus according to a second aspect of the present invention, an apparatus is provided, wherein the switch control section according to the first aspect on/off controls the switches so that the discharging of all the unit cells other than the unit cell having the level closest to the reference voltage is started and so that the discharging of the unit cells is stopped in order beginning with the unit cell having the level close to the reference voltage.

Furthermore, as a voltage detection apparatus according to a third aspect of the present invention, an apparatus is provided, wherein the switch control section according to the first aspect on/off controls the switches so that constant time discharging in which all the unit cells other than the unit cell having the level closest to the reference voltage are discharged for a constant time is repeated intermittently and so that the constant time discharging is stopped in order beginning with the unit cell having the level close to the reference voltage.

### Advantageous Effects of the Invention

With the present invention, the unit cells can be discharged for stepwise discharge times depending on the respective levels corresponding to the voltages across both ends thereof, whereby quick and accurate equalization can be attained with the simple configuration.

### BRIEF DESCRIPTION OF THE DRAWINGS

FIG. 1 is a block diagram showing an embodiment of an equalization device according to the present invention;

FIG. 2 is a circuit diagram showing the details of one of equalization blocks constituting the equalization device shown in FIG. 1;

FIGS. 3(A) to 3(C) are explanatory views illustrating the operation of the equalization device shown in FIG. 1;

FIG. 4 is a flow chart showing the equalization control processing procedure of an MCU constituting the equalization device shown in FIG. 1 according to the first embodiment;

FIG. 5 is a flow chart showing the equalization control processing procedure of an MCU constituting the equalization device shown in FIG. 1 according to a second embodiment; and

FIG. 6(A) is a graph showing examples of the voltages across both ends of unit voltages B1 to B5, and FIG. 6(B) is a graph showing the voltages across both ends after the unit voltages B1 to B5 having the voltages across both ends shown in FIG. 6(A) are discharged for a specified time.

### MODE FOR CARRYING OUT THE INVENTION

### First Embodiment

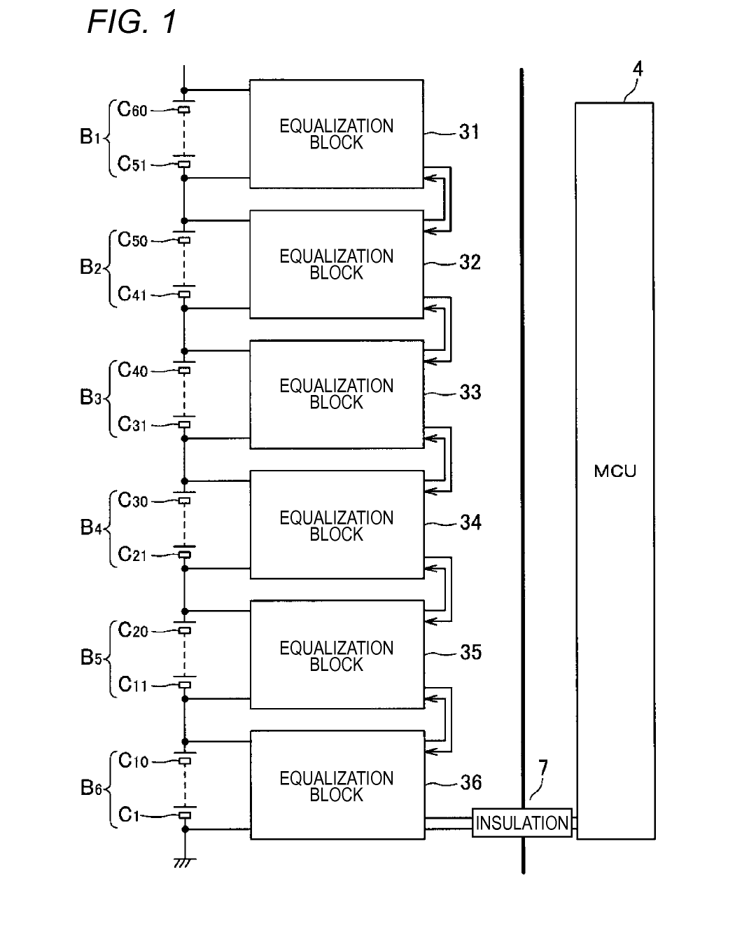

An embodiment of an equalization device according to the present invention will be described below referring to FIGS. 1 to 4. As shown in FIG. 1, an equalization device 1 is an apparatus for equalizing the voltages across both ends of a plurality of unit cells C₁ to C₆₀ mutually connected in series and constituting a battery pack BH. Although each of the above-mentioned unit cells C₁ to C₆₀ is composed of a single secondary battery in this embodiment, the unit cell may also be composed of a plurality of secondary batteries.

For example, in a hybrid electric automobile in which both an engine and an electric motor (both are not shown) are used as traveling drive sources, the battery pack BH is used as the power source of the electric motor. The electric motor is connected as a load across both ends of the battery pack BH as necessary, and an alternator or the like (not shown) is also connected as a charger as necessary. Furthermore, the unit cells C₁ to C₆₀ are divided into, for example, six blocks B1 to B6. In other words, the battery pack BH has six blocks B1 to B6. Each of the blocks B1 to B6 is composed of, for example, ten unit cells.

The equalization device 1 includes a plurality of equalization blocks 31 to 36 for equalizing the respective unit cells C₁ to C₆₀ and an MCU 4 serving as an equalization section for controlling the entire apparatus and controlling the equalization blocks 31 to 36. The equalization blocks 31 to 36 are provided so as to correspond to the blocks B1 to B6, respectively, and operate on the power supplied from the blocks B1 to B6 corresponding thereto. Furthermore, the equalization blocks 31 to 36 detect the respective voltages across both ends of the unit cells C₁ to C₆₀ constituting the blocks B1 to B6 corresponding thereto and transmit the voltages to the MCU 4 and discharge the unit cells C₁ to C₆₀ constituting the blocks B1 to B6 corresponding thereto according to instructions from the MCU 4. The MCU 4 is composed of a microcomputer and operates on the power supplied from a low-voltage battery, not shown, different from the battery pack BH.

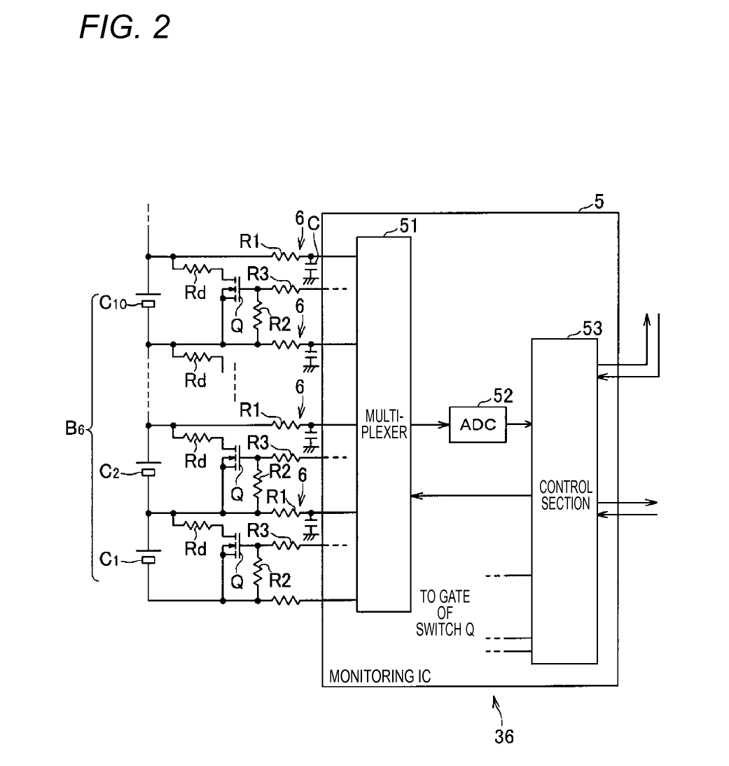

Next, the details of the equalization block 36 will be described referring to FIG. 2. However, since the equalization blocks 31 to 36 have mutually equivalent configurations, the details of the equalization block 36 are herein described, and the details of the equalization blocks 31 to 35 are omitted. The equalization block 36 includes a monitoring IC 5, a plurality of low-pass filters (hereafter simply referred to as “LPF”) 6 each provided between the monitoring IC 5 and the positive terminal of each of the unit cells C₁ to C₁₀, a plurality of discharge resistors Rd each provided for each of the unit cells C₁ to C₁₀, and a plurality of switches Q each connected in series with the discharge resistor Rd across each of the unit cells C₁ to C₁₀.

The monitoring IC 5 will be described later. Each LPF 6 is the so-called CR filter formed of a resistor R1 and a capacitor C as shown in FIG. 2. The resistor R1 is connected between the positive terminal of each of the unit cells C₁ to C₁₀ and the monitoring IC 5. The capacitor C is connected between the connection point of the resistor R1 and the monitoring IC 5 and the negative terminal of the block B6 corresponding thereto. This LPF 6, provided between each of the unit cells C₁ to C₁₀ and the monitoring IC 5, cuts off high-frequency components from the positive potential of each of the unit cells C₁ to C₁₀ and supplies the obtained potential to the monitoring IC 5.

One terminal of each discharge resistor Rd is connected to the positive terminal of each of the unit cells C₁ to C₁₀. The switch Q is composed of, for example, an N-channel field effect transistor, the drain of which is connected to the other terminal of the discharge resistor Rd and the source of which is connected to the negative terminal of each of the unit cells C₁ to C₁₀. With this configuration, when the switch Q is turned on, the discharge resistor Rd is connected across both ends of each of the unit cells C₁ to C₁₀ and each of the unit cells C₁ to C₁₀ is discharged. On the other hand, when the switch Q is turned off, the connection between each of the unit cells C₁ to C₁₀ and the discharge resistor Rd is disconnected, and the discharging of each of the unit cells C₁ to C₁₀ is stopped. Furthermore, a resistor R2 is connected between the gate and the source of the switch Q, the gate of the switch Q is connected to the monitoring IC 5 via a resistor R3, and the switch Q is on/off controlled by the monitoring IC 5.

Next, the details of the monitoring IC 5 will be described. The monitoring IC 5 includes a multiplexer 51 connected across both ends of the unit cells C₁ to C₁₀ and used to select both ends of one of the unit cells C₁ to C₁₀ and to connect both ends to the input of an A/D converter 52 described later; the A/D converter 52 serving as a voltage detection section in which an input analog voltage is converted into a digital voltage and the digital voltage is output to a control section 53; and the control section 53 for control the entire monitoring IC 5.

The control sections 53 of the respective equalization blocks 31 to 36 are mutually connected in series as shown in FIG. 1, and only the control section 53 of the equalization block 36 having the lowest potential can directly communicate with the MCU 4 via an insulation I/F 7. Each of the control sections 53 of the equalization blocks 32 to 35, other than that of the equalization block having the lowest potential, communicates with the MCU 4 via the control section 53 of the equalization block that is located on the lower potential side of the equalization block itself. When the control section 53 receives a voltage detection instruction addressed thereto from the MCU 4, the control section 53 controls the multiplexer 51 and sequentially inputs the potentials on the positive terminal sides of the unit cells C₁ to C₁₀ to the A/D converter 52.

The A/D converter 52 sequentially A/D converts the potentials on the positive terminal sides of the unit cells C₁ to C₁₀ and supplies the converted potentials to the control section 53. The control section 53 transmits to the MCU 4 the digital values of the potentials on the positive terminal sides of the unit cells C₁ to C₁₀ supplied from the A/D converter 52 as detected voltages. At this time, since the control section 53 of the equalization block 36 can directly communicate with the MCU 4, the control section 53 directly transmits the digital values to the MCU 4. The control section 53 of each of the equalization blocks 31 to 35 transmits the detected voltages thereof to the MCU 4 via the control section 53 of one of the equalization blocks 32 to 36 located on the lower potential side of the equalization block itself. The control section 53 is connected to the gates of the respective switches Q and on/off controls the respective switches Q according to the on/off signals transmitted from the MCU 4.

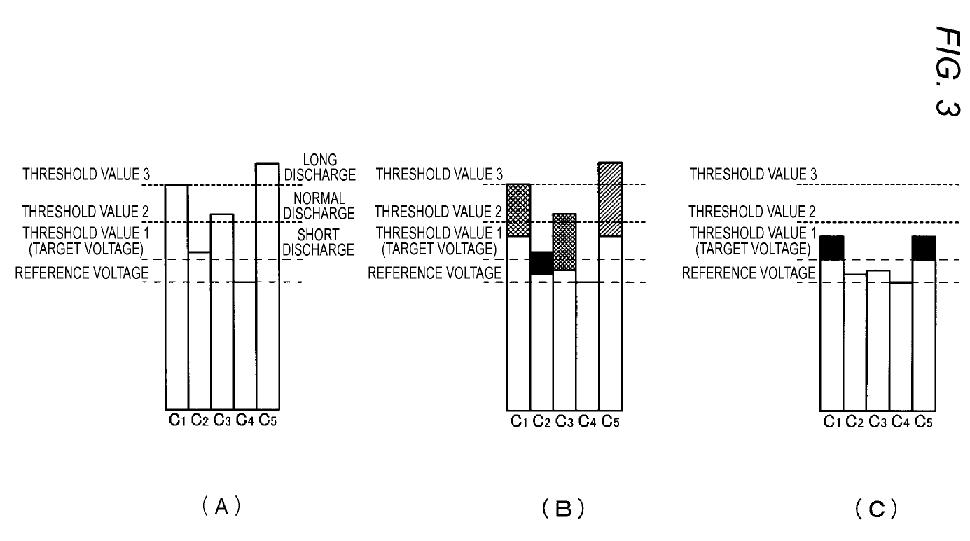

Next, the operation of the equalization device 1 having the above configuration will be described referring to FIGS. 3(A) to 3(C). For ease of explanation, a case in which five unit cells C₁ to C₅ are used to constitute the battery pack BH will be described. First, when a voltage detection instruction is output from a higher order system (not shown) positioned higher in the chain of command than the MCU 4, the MCU 4 detects the voltages across both ends of the unit cells C₁ to C₅. Then, as shown in FIG. 3(A), the MCU 4 sets the voltage across both ends of the unit cells C₄, i.e., the lowest voltage of the voltages of all the unit cells C₁ to C₅ constituting the battery pack BH, to a reference voltage, and classifies the voltages across both ends of the respective unit cells C₁ to C₅ into four levels, “no discharge”, “short discharge”, “normal discharge” and “long discharge”, depending on the differences between the reference voltage and the voltages across both ends of the unit cells C₁ to C₅.

More specifically, the above classification is made by comparing the voltages with a plurality of threshold values 1 to 3 that are set with respect to the reference voltage. In other words, the MCU 4 sets a voltage slightly higher than the reference voltage to threshold value 1 (target voltage), sets a voltage higher than the threshold value 1 to threshold value 2, and sets a voltage higher than the threshold value 2 to threshold value 3.

If the voltage of one of the unit cells C₁ to C₅ is higher than the threshold value 1 (target voltage), the MCU 4 judges that equalization is necessary. Next, the MCU 4 compares the plurality of threshold values 1 to 3 with the voltage across both ends of each of the unit cells C₁ to C₅ and classifies the level of the voltage across both ends of each of the unit cells C₁ to C₅. In this embodiment, the voltage level across both ends of an unit cell being lower than the threshold value 1 is classified as “no discharge”; the voltage level across both ends of an unit cell being equal to or higher than the threshold value 1 and lower than the threshold value 2 is classified as “short discharge”; the voltage level across both ends of an unit cell being equal to or higher than the threshold value 2 and is lower than the threshold value 3 is classified as “normal discharge”; and the voltage level across both ends of an unit cell being higher than the threshold value 3 is classified as “long discharge”. In the example shown in FIG. 3(A), the voltage level of the unit cell C₅ is classified as “long discharge”, the voltage levels of the unit cells C₁ and C₃ are classified as “normal discharge”, the voltage level of the unit cell C₂ is classified as “short discharge”, and the voltage level of the unit cell C₄ is classified as “no discharge”.

Next, the MCU 4 starts the discharging of all the unit cells C₁ to C₃ and C₅ having levels other than the level “no discharge” closest to the reference voltage among the levels, then stops the discharging of the unit cell C₂ having the level “short discharge” next closest to the reference voltage, then stops the discharging of the unit cells C₁ and C₃ having the level “normal discharge” next closest to the reference voltage, and lastly stops the discharging of the unit cell C₅ having the level “long discharge” farthest from the reference voltage. In FIGS. 3(B) and 3(C), the discharge amount of “long discharge” is indicated by the hatching of parallel oblique lines, the discharge amount of “normal discharge” is indicated by the hatching of crossing oblique lines, and the discharge amount of “short discharge” is indicated by the completely blackened hatching. Hence, as shown in FIG. 3(B), the discharge amount can be made smaller in the order of “long discharge”, “normal discharge” and “short discharge”. This discharging is repeated until the voltages across both ends of all the unit cells C₁ to C₅ become equal to or lower than the threshold value 1 (target voltage).

In the example shown in FIG. 3(B), since the voltages of the unit cells C₁ and C₅ are higher than the threshold value 1 (target voltage) as shown in FIG. 3(B) even after the first discharging was performed, the MCU 4 detects the voltages across both ends of the unit cells C₁ to C₅ and classifies the levels thereof. In the example shown in FIG. 3(B), the voltage levels of the unit cells C₁ and C₅ are classified as “short discharge”, and the voltage levels of the unit cells C₂ to C₄ are classified as “no discharge”. Next, the MCU 4 starts the discharging of all the unit cells C₁ and C₅ having levels other than the level “no discharge” and then first stops the discharging of the unit cells C₁ and C₅ having the level “short discharge” in which the voltage level across both ends thereof is low. In this case, since unit cells having levels “normal discharge” and “long discharge” are not existent, the discharging of all the unit cells C₁ to C₅ is ended at this time. In the example shown in FIGS. 3(A) to 3(C), after the second discharging was performed, the voltages across both ends of all the unit cells C₁ to C₅ become equal to or lower than the threshold value 1 (target voltage) as shown in FIG. 3(C), and the voltage level thereof is classified as “no discharge”, the equalization is ended at this time. After the equalization is ended, the MCU 4 detects the voltages across both ends of the unit cells C₁ to C₅ at specific time intervals, and if the voltages have a variation equal to or higher than the threshold value 2, the MCU 4 restarts equalization.

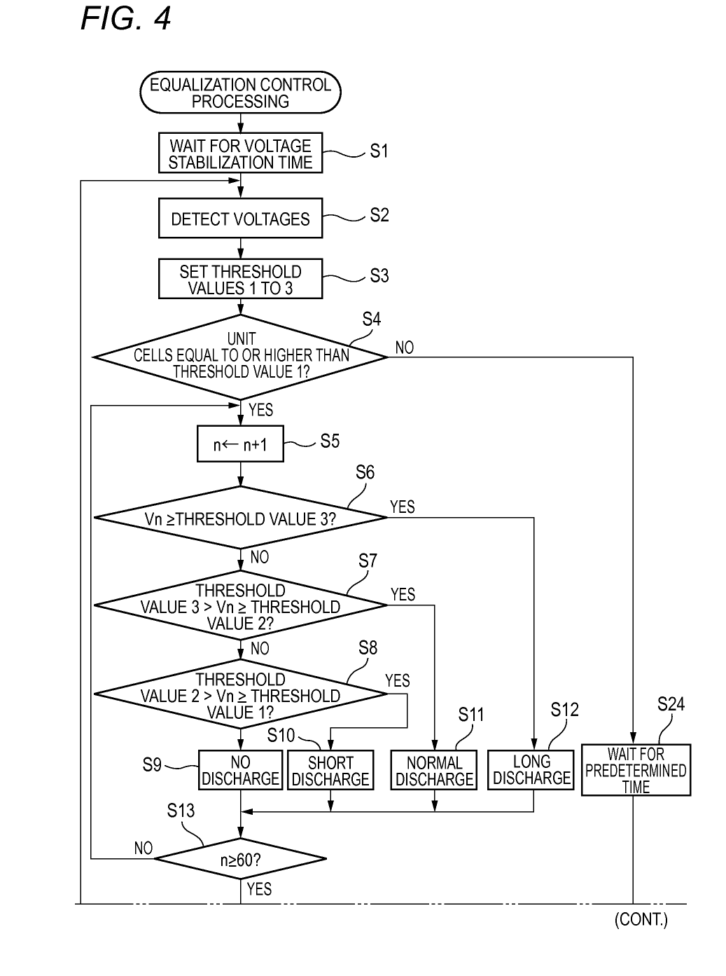

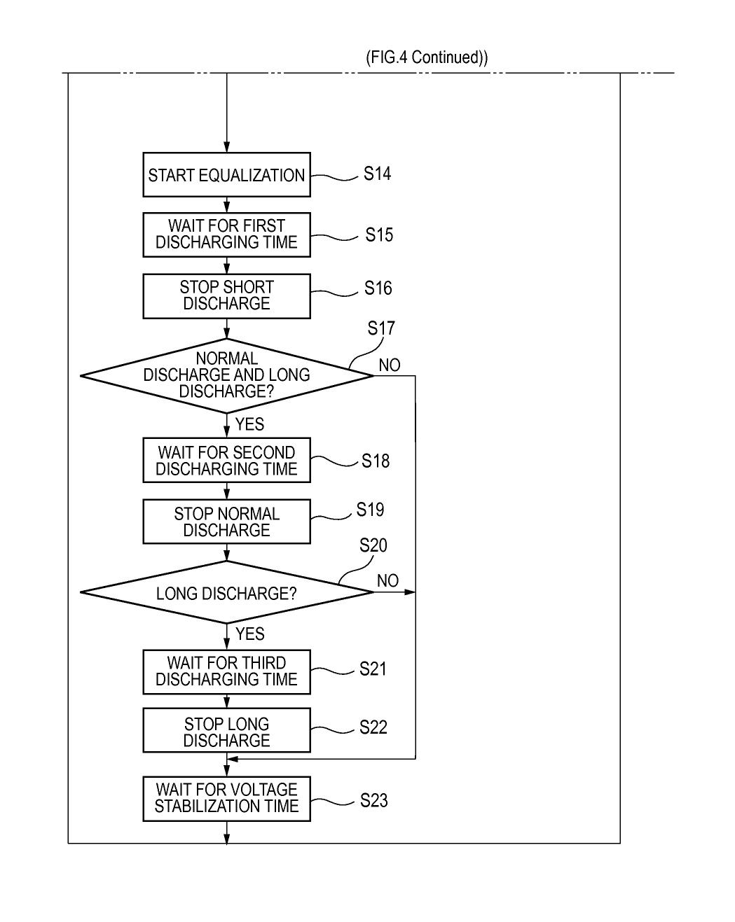

Next, the operation of the equalization device 1 briefly described above will be described referring to FIG. 4. In the case that the MCU 4 itself judges that equalization is necessary or when an equalization instruction is output from a higher order system, not shown, in response to a trigger, such as the on/off operation of the ignition switch, the MCU 4 starts equalization control processing. First, the MCU 4 waits until a voltage stabilization time passes during which the voltages across both ends of the respective unit cells C₁ to C₆₀ stabilize (at step 51).

Then, the MCU 4 sequentially outputs a voltage detection instruction to the control sections 53 of the respective equalization blocks 31 to 36 and detects the voltages across both ends of the unit cells C₁ to C₆₀ (at step S2). When the control section 53 of each of the equalization blocks 31 to 36 receives the voltage detection instruction, the control section 53 judges whether the instruction is addressed thereto. In the case that the control section 53 receives the voltage detection instruction not addressed thereto, the control section 53 transfers the voltage detection instruction to the control section 53 of the adjacent equalization block, i.e., one of the equalization blocks 31 to 35, located on the higher potential side. On the other hand, in the case that the control section 53 receives the voltage detection instruction addressed thereto, the control section 53 controls the multiplexer 51 so that the positive potentials of the unit cells C₁ to C₆₀ are sequentially input to the A/D converter 52. Hence, the A/D converter 52 sequentially A/D converts the positive potentials of the unit cells C₁ to C₆₀, and the control section 53 sequentially transmits the potentials as detected voltages to the MCU 4.

The detected voltages transmitted from the control section 53 of the equalization block 36 are directly transmitted to the MCU 4. The detection voltages transmitted from the control section 53 of one of the equalization blocks 31 to 35 are transmitted to the MCU 4 via the control section 53 of the equalization blocks 32 to 36 that is located on the lower potential side of the equalization block itself. Hence, the positive potentials of the unit cells C₁ to C₆₀ are sequentially transmitted to the MCU 4; upon receiving the potentials, the MCU 4 calculates the voltages across both ends of the unit cells C₁ to C₆₀.

Next, the MCU 4 operates as a threshold setting section, uses the lowest voltage of the voltages across both ends of the unit cells C₁ to C₆₀ as the reference voltage, and sets the plurality of threshold values 1 to 3 that become higher stepwise from the reference voltage (at step S3).

Then, the MCU 4 judges whether any one of the voltages across both ends of all the unit cells C₁ to C₆₀ is equal to or higher than the threshold value 1 (target voltage) (at step S4). In the case that there is no voltage being equal to or higher than the threshold value 1 (target voltage) (in the case of “false” at step S4; the case of “false” is hereafter described as “N”), the MCU 4 judges that equalization is not necessary, waits until a predetermined time passes (at step S24), and returns to step S2.

On the other hand, in the case that any one of the voltages is equal to or higher than the threshold value 1 (in the case of “true” at step S4; the case of “true” is hereafter described as “Y”), the MCU 4 advances to step S5 to step S13, operates as a classification section and compares the plurality of threshold values 1 to 3 with the voltages across both ends of the unit cells C₁ to C₆₀, and classifies the levels of the voltages of the unit cells C₁ to C₆₀ into four levels, “no discharge”, “short discharge”, “normal discharge” and “long discharge”. In more detail, the MCU 4 first performs the setting of n←n+1 (at step S5). Since n=0 has been set at the initial setting, n=1 is set at step S5 serving as the first step from the start of the equalization control processing. Next, in the case that the voltage Vn across both ends of a unit cell Cₙ is equal to or higher than the threshold value 3 (Y at step S6), the MCU 4 classifies the level of the voltage Vn across both ends of the unit cell Cₙ as “long discharge” (at step S12).

Furthermore, in the case that the voltage Vn across both ends of the unit cell Cₙ is lower than the threshold value 3 and is equal to or higher than the threshold value 2 (Y at step S7), the MCU 4 classifies the level of the voltage Vn across both ends of the unit cell Cₙ as “normal discharge” (at step S11). Furthermore, in the case that the voltage Vn across both ends of the unit cell Cₙ is lower than the threshold value 2 and is equal to or higher than the threshold value 1 (Y at step S8), the MCU 4 classifies the level of the voltage Vn across both ends of the unit cell Cₙ as “short discharge” (at step S10). Moreover, in the case that the voltage Vn across both ends of the unit cell Cₙ is lower than the threshold value 1 (N at step S8), the MCU 4 classifies the level of the voltage Vn across both ends of the unit cell Cₙ as “no discharge” (at step S9).

After the level of the voltage Vn across both ends was classified at steps S9 to S12, the MCU 4 judges whether n≧60 (60=the number of cells) is satisfied (at step S13). In the case that n≧60 is not satisfied (N at step S13), the MCU 4 returns to step S5. In the case of n≧60 (Y at step S13), the MCU 4 judges that the levels of the voltages across both ends V₁ to V₆₀ of all the unit cells C₁ to C₆₀ have been classified, resets n to 0 and advances to step S14. The MCU 4 hereafter operates as a switch control section.

At step S14, the MCU 4 transmits the switch Q on/off signals for discharging the unit cells C₁ to C₆₀ having the levels “long discharge”, “normal discharge” and “short discharge”, other than “no discharge”, to the respective equalization blocks 31 to 36. In the case that the control section 53 of each of the equalization blocks 31 to 36 receives the on/off signal addressed thereto, the control section 53 turns on/off the switches Q in accordance with the on/off signal. Hence, both ends of the unit cells C₁ to C₆₀ having the levels “long discharge”, “normal discharge” and “short discharge” are connected across the discharge resistors Rd, and discharging is performed.

Then, the MCU 4 waits until a first discharging time passes (at step S15) and transmits the on/off signals for stopping the discharging of the unit cells having the level “short discharge” to the respective equalization blocks 31 to 36 (at step S16). In the case that the control section 53 of each of the equalization blocks 31 to 36 receives the on/off signal addressed thereto, the control section 53 turns on/off the switches Q in accordance with the on/off signal. Hence, both ends of the unit cells C₁ to C₆₀ having the level “short discharge” are disconnected from the discharge resistors Rd, and the discharging is stopped.

Then, in the case that the unit cells C₁ to C₆₀ having the levels “normal discharge” and “short discharge” are not existent (N at step S17), the MCU 4 immediately advances to step S23, waits until a voltage stabilization time passes, during which the voltages across both ends of the respective unit cells C₁ to C₆₀ stabilize, and then returns to step S2. On the other hand, in the case that the unit cells C₁ to C₆₀ having the levels “normal discharge” and “long discharge” are existent (Y at step S17), the MCU 4 waits until a second discharging time passes (at step S18) and transmits the on/off signals for stopping the discharging of the unit cells C₁ to C₆₀ having the level “normal discharge” to the respective equalization blocks 31 to 36 (at step S19). In the case that the control section 53 of each of the equalization blocks 31 to 36 receives the on/off signal addressed thereto, the control section 53 turns on/off the switches Q in accordance with the on/off signal. Hence, both ends of the unit cells C₁ to C₆₀ having the level “normal discharge” are disconnected from the discharge resistors Rd, and the discharging is stopped.

Then, in the case that the unit cells C₁ to C₆₀ having the level “long discharge” are not existent (N at step S20), the MCU 4 immediately advances to step S23 and then returns to step S2. On the other hand, in the case that the unit cells C₁ to C₆₀ having the level “long discharge” are existent (Y at step S20), the MCU 4 waits until a third discharging time passes (at step S21), transmits the on/off signals for stopping the discharging of the unit cells having the level “long discharge” to the respective equalization blocks 31 to 36 (at step S22), and then advances to step S23. In the case that the control section 53 of each of the equalization blocks 31 to 36 receives the on/off signal addressed thereto, the control section 53 turns on/off the switches Q in accordance with the on/off signal. Hence, both ends of the unit cells C₁ to C₆₀ having the level “long discharge” are disconnected from the discharge resistors Rd, and the discharging is stopped.

With the above embodiment, the MCU 4 on/off controls the switches Q so that the unit cells having the level “no discharge” closest to the reference voltage are not discharged and so that the unit cells having the other levels are discharged such that the unit cell having a level farther from the reference voltage is discharged for a longer time. This discharging will be described referring to FIGS. 3(A) to 3(C); the discharging times of the unit cell C₂ having the level “short discharge”, the unit cell C₁ and C₃ having the level “normal discharge” and the unit cell C₅ having the level “long discharge” become longer in this order, and the discharge amounts thereof become larger in this order. Hence, the unit cells C₁ to C₆₀ can be discharged for stepwise discharge times depending on the respective levels corresponding to the voltages across both ends thereof, whereby quick and accurate equalization can be attained with the simple configuration.

In other words, in the case that a plurality of threshold values are set and that the setting of a plurality of discharge times is made possible, fine voltage adjustment can be made, and the voltages across both ends of the respective unit cells C₁ to C₆₀ can be adjusted accurately. Furthermore, since the discharge times of the unit cells C₁ to C₆₀ can be set short, some of the unit cells C₁ to C₆₀ required to be discharged only slightly are not discharged wastefully, whereby the equalization of the unit cells C₁ to C₆₀ can be performed efficiently.

Moreover, in the case that a plurality of threshold values are set and that discharging is performed while the discharge times are classified into several patterns (three patterns in the first embodiment), instead of calculating and setting discharge times for the respective unit cells C₁ to C₆₀, the RAM area to be used by the monitoring IC 5 can be reduced. Still further, the monitoring IC 5 enters a sleep state during discharging, and then each time the switch Q is turned on/off and the next discharging is performed, the monitoring IC 5 is waken up. Hence, in the case that the discharge times have been calculated and set for the respective unit cells C₁ to C₆₀, the monitoring IC 5 is required to be waken up the number of times corresponding to the number of the unit cells required to be discharged; however, in the case that the discharge times are classified into several patterns, the number of times the monitoring IC 5 is waken up can be reduced, and current consumption can also be reduced.

### Second Embodiment

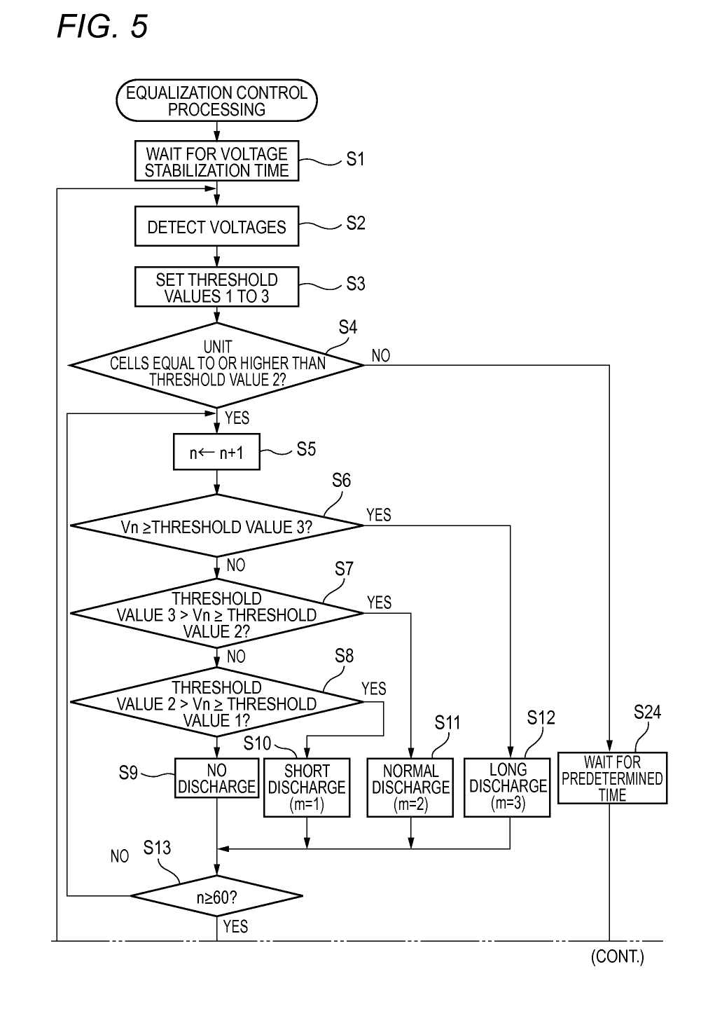

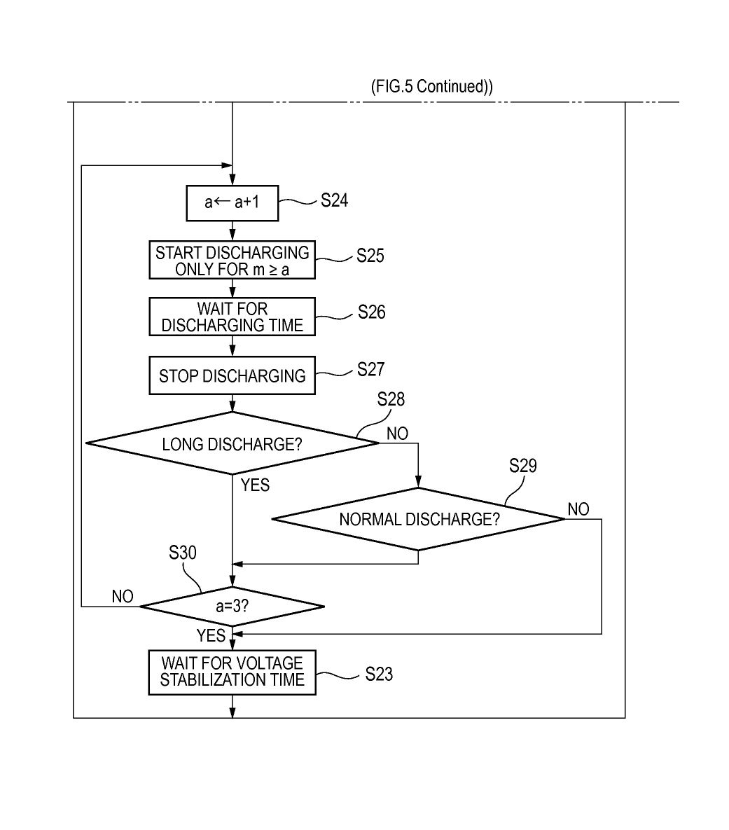

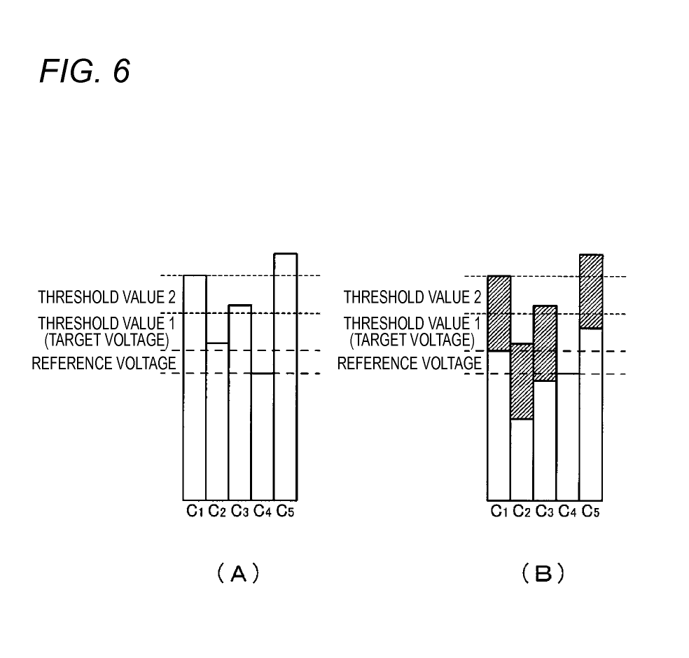

Next, an equalization device 1 according to a second embodiment will be described. Since the configuration of the equalization device 1 according to the second embodiment is similar to the configuration shown in FIG. 1 and having already been described in the first embodiment, the detailed destinations thereof are herein omitted. Then, the operation of the equalization device 1 according to the second embodiment will be described referring to FIG. 5. Steps similar to the above operation steps in the first embodiment described referring to FIG. 4 are designated by the same reference signs and their detailed descriptions are omitted.

First, in the case that the MCU 4 itself judges that equalization is necessary or in response to a trigger, such as the on/off operation of the ignition switch, the MCU 4 executes processing from step 51 to step S13 as in the case of the first embodiment. At steps S10 to S12, the MCU 4 classifies the levels of the voltages across both ends of the unit cells Cn into “no discharge”, “short discharge”, “normal discharge” and “long discharge”, and assigns number m to the levels other than the “no discharge”. For example, m=1 is assigned to “short discharge”, m=2 is assigned to “normal discharge”, and m=3 is assigned to “long discharge”.

Then, the MCU 4 performs the setting of a←a+1 (at step S24). Since a=0 has been set at the initial setting, a=1 is set at step S24 serving as the first step from the start of the equalization control processing. Next, the MCU 4 transmits the switch Q on/off signals for discharging the unit cells C₁ to C₆₀ having the levels m a to the respective equalization blocks 31 to 36 (at step S25). In the case that the control section 53 of each of the equalization blocks 31 to 36 receives the on/off signal addressed thereto, the control section 53 turns on/off the switches Q in accordance with the on/off signal. Hence, both ends of the unit cells C₁ to C₆₀ having the levels m a are connected across the discharge resistors Rd, and discharging is performed. Hence, when a=1 has been set, the unit cells C₁ to C₆₀ having the three levels “short discharge”, “normal discharge” and “long discharge” are discharged; and when a=2 has been set, the unit cells C₁ to C₆₀ having the two levels “normal discharge” and “long discharge” are discharged; and when a=3 has been set, the unit cells C₁ to C₆₀ having the level “long discharge” are discharged.

Then, the MCU 4 waits until a discharging time (constant time) passes (at step S26) and transmits the on/off signals for stopping the discharging of all the unit cells C₁ to C₆₀ to the respective equalization blocks 31 to 36 (at step S27). And then, in the case that the unit cells C₁ to C₆₀ having the level long discharge or normal discharge are existent (Y at step S28 or Y at step S29), the MCU 4 judges whether a=3 is satisfied (at step S30). In the case that a=3 is not satisfied (N at step S30), the MCU 4 returns to step S24. In the case that a=3 is satisfied (Y at step S30), the MCU 4 judges that discharging up to “long discharge” has been able to be performed, resets a to 0, and advances to step S23.

In the processing at steps S24 to S30, the MCU 4 intermittently repeats constant time discharging in which all the unit cells C₁ to C₆₀ having the levels other than the level “no discharge” closest to the reference voltage among the levels are discharged for a discharge time, and stops the constant time discharging in order beginning with the unit cells C₁ to C₆₀ having the level closer to the reference voltage. More specifically, in this embodiment, the constant time discharging is repeated three times for the unit cells C₁ to C₆₀ having the level “long discharge”, the constant time discharging is repeated two times for the unit cells C₁ to C₆₀ having the level “normal discharge”, and the constant time discharging is performed once for the unit cells C₁ to C₆₀ having the level “short discharge”. With this second embodiment, an effect similar to that obtained in the first embodiment can also be obtained.

In the above embodiments, although the number of the unit cells C₁ to C₆₀ constituting the battery pack BH is 60, the number according to the present invention is not limited to the above number. The number of the unit cells C₁ to C₆₀ may be plural and is not limited to 60.

In addition, in the above embodiments, although the levels of the voltages across both ends of the respective unit cells C₁ to C₆₀ are classified into four levels, “no discharge”, “long discharge”, “normal discharge” and “short discharge”, the number of the levels according to the present invention is not limited to the above number. The levels of the voltages across both ends of the respective unit cells C₁ to C₆₀ may merely be classified into three or more levels.

Furthermore, in the above embodiments, although the threshold values and the number of the levels with respect to the reference voltage are constant regardless of the variation in the unit cells C₁ to C₆₀, the threshold values and the number of the levels according to the present invention are not limited to be constant. For example, the threshold values and the number of the levels may be changed depending on the variation in the unit cells C₁ to C₆₀ (the difference between the maximum and minimum values of the voltages across both ends of the unit cells C₁ to C₆₀).

Moreover, in the above embodiments, although the equalization is performed by comparing the voltages across both ends of the unit cells with the threshold values having been set with respect to the reference voltage, the equalization according to the present invention is not limited to be performed by this method. For example, the voltage difference between the reference voltage and the voltage across both ends of each unit cell may be obtained and that the judgment as to whether the voltage is equal to or lower than a threshold value may be made depending on the voltage difference.

Still further, the above embodiments are merely typical embodiments according to the present invention, and the present invention is not limited to the embodiments. In other words, the present invention can be modified variously and embodied within a range not deviated from the gist of the present invention.

The features of the above embodiments of the connector according to the present invention will be briefly summarized in the items [1] to [5] listed below.

[1] The equalization device (1) for equalizing the voltages across both ends of the plurality of unit cells (C₁ to C₆₀) mutually connected in series, the equalization device including:

the voltage detection section (A/D converter 52) that detects the voltages across both ends of the respective unit cells;

the plurality of discharge resistors (Rd) that discharge the unit cells, each of the unit cells being provided for each of the unit cells;

the plurality of switches (Q) configured to connect the unit cells to the discharge resistors; and

the equalization section (MCU 4) that equalizes the unit cells by controlling the switches,

wherein the equalization section defines the lowest voltage of the voltages across both ends detected by the voltage detection sections as a reference voltage, and includes a classification section (MCU 4) that classifies the voltages across both ends of the respective unit cells into 3 levels or more in accordance with the differences between the reference voltage and the voltages across both ends of the respective unit cells detected by the voltage detection sections; and the switch control section (MCU 4) that on/off controls the switches so that the unit cell having the level closest to the reference voltage is not discharged and so that, among from the unit cells having the other levels, the unit cell having a level farther from the reference voltage is discharged longer.

[2] The equalization device described in item [1], wherein the switch control section on/off controls the switches so that the discharging of all the unit cells other than the unit cell having the level closest to the reference voltage is started and so that the discharging of the unit cells is stopped in order beginning with the unit cell having the level close to the reference voltage.

[3] The equalization device described in item [1], wherein the switch control section on/off controls the switches so that a constant time discharging in which all the unit cells other than the unit cell having the level closest to the reference voltage are discharged for a constant time is repeated intermittently and so that the constant time discharging is stopped in order beginning with the unit cell having the level close to the reference voltage.

Although the present invention has been described in detail referring to the specific embodiments, it is obvious to those skilled in the art that the present invention can be changed and modified variously without departing from the spirit and scope of the present invention.

This application is based on Japanese Patent Application (JP-2012-230605) filed on Oct. 18, 2012, the entire contents of which are hereby incorporated by reference.

### INDUSTRIAL APPLICABILITY

With the equalization device according to the present invention, the unit cells can be discharged for stepwise discharge times depending on the respective levels corresponding to the voltages across both ends thereof, whereby quick and accurate equalization can be attained with the simple configuration. The present invention having this effect is useful in the field of an equalization device for equalizing the voltages across both ends of a plurality of unit cells mutually connected in series.

### DESCRIPTION OF REFERENCE NUMERALS AND SIGNS

1 equalization device
4 MCU (equalization section, classification section, switch control section)
52 A/D converter (voltage detection section)
C₁ to C₆₀ unit cell
Q switch
Rd discharge resistor

1. An equalization device for equalizing voltages across both ends of a plurality of unit cells mutually connected in series, the equalization device comprising:
a voltage detection section that detects the voltages across both ends of the respective unit cells;
a plurality of discharge resistors that discharge the unit cells, each of the unit cells being provided for each of the unit cells;
a plurality of switches configured to connect the unit cells to the discharge resistors; and
an equalization section that equalizes the unit cells by controlling the switches,
wherein the equalization section defines the lowest voltage of the voltages across both ends detected by the voltage detection section as a reference voltage, and comprises:
a classification section that classifies the voltages across both ends of the respective unit cells into 3 levels or more in accordance with the differences between the reference voltage and the voltages across both ends of the respective unit cells detected by the voltage detection sections; and
a switch control section that on/off controls the switches so that the unit cell having the level closest to the reference voltage is not discharged and so that, among from the unit cells having the other levels, the unit cell having a level farther from the reference voltage is discharged longer.

2. The equalization device according to claim 1, wherein the switch control section on/off controls the switches so that the discharging of all the unit cells other than the unit cell having the level closest to the reference voltage is started and so that the discharging of the unit cells is stopped in order beginning with the unit cell having the level close to the reference voltage.

3. The equalization device according to claim 1, wherein the switch control section on/off controls the switches so that a constant time discharging in which all the unit cells other than the unit cell having the level closest to the reference voltage are discharged for a constant time is repeated intermittently and so that the constant time discharging is stopped in order beginning with the unit cell having the level close to the reference voltage.
